(19) United States
(12) Patent Application Publication
(10) Pub. No.: US 2022/0363828 A1
(43) Pub. Date: Nov. 17, 2022

(54) PREPARATION METHOD OF REPROCESSABLE THERMOSETTING POLYESTERAMIDE (PEA), AND THERMOSETTING PEA PREPARED THEREBY

(71) Applicant: ANHUI AGRICULTURAL UNIVERSITY, Hefei (CN)

(72) Inventors: Zhongkai WANG, Hefei (CN); Yongliang DING, Hefei (CN); Cheng LIU, Hefei (CN)

(73) Assignee: ANHUI AGRICULTURAL UNIVERSITY, Hefei (CN)

(21) Appl. No.: 17/864,458

(22) Filed: Jul. 14, 2022

Related U.S. Application Data
(63) Continuation of application No. PCT/CN2022/071753, filed on Jan. 13, 2022.

(30) Foreign Application Priority Data
Jan. 26, 2021 (CN) 202110103207.1

(51) Int. Cl. C08G 69/44

(52) U.S. Cl. CPC C08G 69/44

(57) ABSTRACT

A preparation method of a reprocessable thermosetting polyesteramide (PEA) includes: (1) mixing 30 to 200 parts by weight of a liquid dicarboxylic acid and 15 to 95 parts by weight of a β-hydroxyl-containing diamine compound, and heating for dissolution to obtain a reaction solution; (2) adding 0.05 to 0.5 parts by weight of a catalyst to the reaction solution, and heating under a nitrogen atmosphere to allow a reaction at 65° C. to 100° C. for 1 h to 6 h; (3) heating a reaction system obtained in step (2) to allow a reaction at 100° C. to 180° C. for 3 h to 18 h; (4) heating a reaction system obtained in step (3) to allow a reaction at 180° C. to 240° C. for 0.5 h to 4 h; and (5) cooling a reaction system obtained in step (4) to 100° C. to 180° C. A PEA prepared by the above preparation method is further provided.

### CROSS REFERENCE TO THE RELATED APPLICATIONS

This application is a continuation application of the national phase entry of International Application No. PCT/CN2022/071753, filed on Jan. 13, 2022, which is based upon and claims priority to Chinese Patent Application No. 202110103207.1, filed on Jan. 26, 2021, the entire contents of which are incorporated herein by reference.

### TECHNICAL FIELD

The present disclosure relates to the technical field of polyesteramide (PEA) resins, and in particular to a preparation method of a reprocessable thermosetting PEA, and a thermosetting PEA prepared thereby.

### BACKGROUND

Common synthetic polymer resins can be divided into thermosetting resins and thermoplastic resins. When a thermoplastic resin is heated to a specified temperature, its intermolecular interaction will be destroyed to make the thermoplastic resin have fluidity. For example, the common molecular chain entanglement, van der Waals force, and hydrogen bond will weaken or disappear. Therefore, the thermoplastic resins have reprocessibility. However, the thermosetting resins themselves do not have reprocessability due to the limitation of a cross-linked network of covalent bonds. Therefore, the thermosetting resin materials have excellent thermal stability. For example, common plug boards, switch panels, and the like are each made of a thermosetting resin.

The thermosetting resins have good dimensional stability and are widely used in various aspects of life, but it cannot be ignored that the thermosetting resin materials cannot be recycled and cause environmental pollution and a waste of resources. Many reprocessable thermosetting resins have been developed in recent years, and the reprocessibility is enabled by introducing a dynamic covalent bond into a material, but bio-based thermosetting resin materials are still rarely reported. For example, Chinese patent CN110903463A discloses a reprocessable and shape-memory vegetable oil-based thermosetting epoxy resin and a preparation method thereof. A sample of the epoxy resin is cut into pieces and heated to 130° C. to 200° C. and a specified pressure is applied to make the sample under dynamic transesterification conditions, such that a topological structure of the cross-linked network can be rearranged and the sample can be reprocessed into another shape.

It is well known that a dimer acid refers to a dimer obtained from the self-polycondensation, such as a Diels-Alder cycloaddition reaction, of a linear unsaturated fatty acid or unsaturated fatty acid ester with linoleic acid of natural oil as a main component under the catalysis of clay. A dimer acid still remains in a liquid state at room temperature due to the presence of long side chains in its structure. At present, dimer acids are mainly used in coatings, surfactants, lubricants, printing inks, hot melt adhesives, and the like. Dimer acids have not been found to be used in resins because it is a mixture composed of a dimer, a small amount of a trimer or a multimer, and a trace amount of an unreacted monomer and it is difficult to directly prepare a high-performance polyamide (PA) by polycondensation of the dimer acid with a diamine monomer in equal proportions. In addition, although a reaction of a dimer acid with a polyamine to prepare a curing agent has been reported, there is still much work to be done to figure out how a dimer acid can be used to prepare high-performance plastics.

### SUMMARY

The technical problem to be solved by the present disclosure is that the PA synthesized with a dimer acid in the prior art has poor performance.

The present disclosure solves the above technical problem through the following technical solutions:

The present disclosure provides a preparation method of a reprocessable thermosetting PEA, including the following steps:

(1) mixing 30 to 200 parts by weight of a liquid dicarboxylic acid and 15 to 95 parts by weight of a β-hydroxyl-containing diamine compound, heating for dissolution, and thoroughly stirring to obtain a reaction solution;

(2) adding 0.05 to 0.5 parts by weight of a catalyst to the reaction solution, and heating under a nitrogen atmosphere to allow a reaction at 65° C. to 100° C. for 1 h to 6 h;

(3) heating a reaction system obtained in step (2) to allow a reaction at 100° C. to 180° C. for 3 h to 18 h;

(4) heating a reaction system obtained in step (3) to allow a reaction at 180° C. to 240° C. for 0.5 h to 4 h; and

(5) cooling a reaction system obtained in step (4) to 100° C. to 180° C. to obtain the reprocessable thermosetting PEA.

Beneficial effects: An amide bond, an ester bond, and a hydroxyl group coexist in the PEA prepared by the present disclosure, such that the PEA can be reprocessed while exhibiting high heat resistance. In addition, the reaction monomer is not affected by the monomer purity, such that the liquid dicarboxylic acid has a promising application prospect in reprocessable thermosetting resins. The prepared PEA has a breaking strength of 1 MPa to 100 MPa and an elongation at break of 1% to 500%.

The liquid dicarboxylic acid used allows an initial reaction system to be still in a molten state at a low temperature and allows the reaction to proceed smoothly at a low temperature, such that the amino groups can react as much as possible at an initial stage of the reaction, thereby enabling the presence of hydroxyl groups at a reaction end point.

The PEA in the present disclosure is synthesized from a dimer acid compound and a β-hydroxyl-containing diamine compound without a solvent. The synthesis method is simple and causes no environmental pollution, and the product does not require purification and can be easily recycled.

The dimer acid monomer for synthesizing the PEA in the present disclosure is not affected by purity and can be monofunctional or multifunctional. A mechanical strength of the PEA can be controlled by controlling the feeding amount of the liquid dicarboxylic acid.

The introduction of nitrogen during the preparation process of the present disclosure can prevent the material from being oxidized at a high temperature and purge the generated small molecules to promote the forward progress of the reaction.

The multi-step heating involves a degree of reaction, the selection of reaction conditions is based on long-term experimental exploration, the reaction conditions are controlled, and the low-temperature time is extended as much as possible to increase a reaction proportion of the amino groups, such that the activity of the amino groups is higher than the activity of hydroxyl groups, and thus hydroxyl groups are not easy to react at a low temperature. The temperature is maintained at 100° C. to 180° C. for a long time to make the amino groups in the monomer completely react as much as possible, such that the hydroxyl groups are still retained at a reaction end point and the generated polymer can be reprocessed. The multi-step heating and cooling is conducted to take out the material at a low temperature and prevent the material from being oxidized by air.

If reaction proportions or conditions are not within a specified range, the product has degraded mechanical properties but still has reprocessibility. This is because the monomer feeding under conditions beyond the specified ranges causes the polymer to have many small molecules, resulting in deteriorated mechanical properties.

Preferably, a ratio of a molar mass of carboxylic acid in the liquid dicarboxylic acid to a molar mass of the amino group in the β-hydroxyl-containing diamine compound may be (0.5-1.5):1.

Beneficial effects: The parts by weight of each raw material are calculated according to a molar ratio of the monomers used. Different molar ratios correspond to different mechanical properties. Therefore, a molar ratio of raw materials is adjusted by adjusting the parts by weight of each raw material to ensure that a feeding amount of carboxyl groups in the liquid dicarboxylic acid is greater than or equal to a feeding amount of amino groups in the diamine.

Preferably, the liquid dicarboxylic acid may have a structural formula of

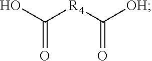

and the β-hydroxyl-containing diamine compound may have a structural formula of

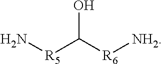

Preferably, the catalyst may include any one selected from the group consisting of sodium phosphite, sodium hypophosphite (SHP), and zinc acetate.

Preferably, the liquid dicarboxylic acid may include a tall oil-derived diacid

Preferably, the liquid dicarboxylic acid may include one or more selected from the group consisting of the following structural formulas:

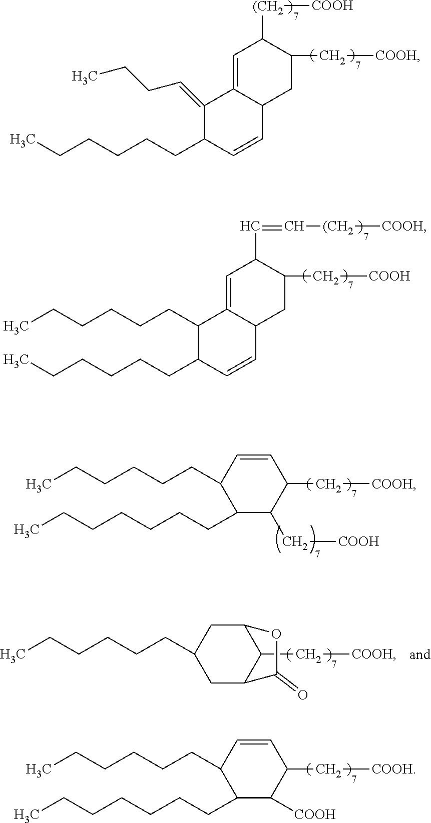

Preferably, the β-hydroxyl-containing diamine compound may be 1,3-diamino-2-propanol.

Preferably, the preparation method of a reprocessable thermosetting PEA may include the following steps:

(1) mixing 41.6 g of a tall oil-derived diacid and 6.8 g of the 1,3-diamino-2-propanol, heating for dissolution, and thoroughly stirring to obtain a reaction solution;

(2) adding 80 mg of sodium phosphite to the reaction solution, and heating under a nitrogen atmosphere to allow a reaction at 80° C. for 1 h;

(3) heating a reaction system obtained in step (2) to allow a reaction at 140° C. for 12 h and then allow a reaction at 180° C. for 6 h;

(4) heating a reaction system obtained in step (3) to allow a reaction at 230° C. for 2 h; and

(5) cooling a reaction system obtained in step (4) to 140° C. to obtain the reprocessable thermosetting PEA.

Preferably, the preparation method of a reprocessable thermosetting PEA may include the following steps:

(1) mixing 38.4 g of a tall oil-derived diacid and 6.8 g of the 1,3-diamino-2-propanol, heating for dissolution, and thoroughly stirring to obtain a reaction solution;

(2) adding 80 mg of sodium phosphite to the reaction solution, and heating under a nitrogen atmosphere to allow a reaction at 80° C. for 1 h;

(3) heating a reaction system obtained in step (2) to allow a reaction at 140° C. for 12 h and then allow a reaction at 180° C. for 6 h;

(4) heating a reaction system obtained in step (3) to allow a reaction at 230° C. for 2 h; and

(5) cooling a reaction system obtained in step (4) to 140° C. to obtain the reprocessable thermosetting PEA.

Preferably, the preparation method of a reprocessable thermosetting PEA may include the following steps:

(1) mixing 35.2 g of a tall oil-derived diacid and 6.8 g of the 1,3-diamino-2-propanol, heating for dissolution, and thoroughly stirring to obtain a reaction solution;

(2) adding 80 mg of sodium phosphite to the reaction solution, and heating under a nitrogen atmosphere to allow a reaction at 80° C. for 1 h;

(3) heating a reaction system obtained in step (2) to allow a reaction at 140° C. for 12 h and then allow a reaction at 180° C. for 6 h;

(4) heating a reaction system obtained in step (3) to allow a reaction at 230° C. for 2 h; and

(5) cooling a reaction system obtained in step (4) to 140° C. to obtain the reprocessable thermosetting PEA.

Preferably, the preparation method of a reprocessable thermosetting PEA may include the following steps:

(1) mixing 44.8 g of a tall oil-derived diacid and 6.8 g of the 1,3-diamino-2-propanol, heating for dissolution, and thoroughly stirring to obtain a reaction solution;

(2) adding 80 mg of sodium phosphite to the reaction solution, and heating under a nitrogen atmosphere to allow a reaction at 80° C. for 1 h;

(3) heating a reaction system obtained in step (2) to allow a reaction at 140° C. for 12 h and then allow a reaction at 180° C. for 6 h;

(4) heating a reaction system obtained in step (3) to allow a reaction at 230° C. for 2 h; and

(5) cooling a reaction system obtained in step (4) to 140° C. to obtain the reprocessable thermosetting PEA.

Preferably, the preparation method of a reprocessable thermosetting PEA may include the following steps:

(1) mixing 32 g of a tall oil-derived diacid and 6.8 g of the 1,3-diamino-2-propanol, heating for dissolution, and thoroughly stirring to obtain a reaction solution;

(2) adding 80 mg of sodium phosphite to the reaction solution, and heating under a nitrogen atmosphere to allow a reaction at 80° C. for 1 h;

(3) heating a reaction system obtained in step (2) to allow a reaction at 140° C. for 12 h and then allow a reaction at 180° C. for 6 h;

(4) heating a reaction system obtained in step (3) to allow a reaction at 230° C. for 2 h; and

(5) cooling a reaction system obtained in step (4) to 140° C. to obtain the reprocessable thermosetting PEA.

The present disclosure also provides a thermosetting PEA prepared by the above preparation method.

Beneficial effects: An amide bond, an ester bond, and a hydroxyl group co-exist in the thermosetting PEA prepared in the present disclosure, such that the PEA can be reprocessed while exhibiting high heat resistance.

The PEA in the present disclosure has a breaking strength of 1 MPa to 100 MPa and an elongation at break of 1% to 500%.

The present disclosure has the following advantages: An amide bond, an ester bond, and a hydroxyl group coexist in the PEA prepared by the present disclosure, such that the PEA can be reprocessed while exhibiting high heat resistance. In addition, the reaction monomer is not affected by the monomer purity, such that the liquid dicarboxylic acid has a promising application prospect in reprocessable thermosetting resins. The prepared PEA has a breaking strength of 1 MPa to 100 MPa and an elongation at break of 1% to 500%.

The liquid dicarboxylic acid used allows an initial reaction system to be still in a molten state at a low temperature and allows the reaction to proceed smoothly at a low temperature, such that the amino groups can react as much as possible at an initial stage of the reaction, thereby enabling the presence of hydroxyl groups at a reaction end point.

The PEA in the present disclosure is synthesized from a dimer acid compound and a β-hydroxyl-containing diamine compound without a solvent. The synthesis method is simple and causes no environmental pollution, and the product does not require impurity removal and purification and can be easily recycled.

The dimer acid monomer for synthesizing the PEA in the present disclosure is not affected by purity and can be monofunctional or multifunctional, and a mechanical strength of the PEA can be controlled by controlling a feeding amount of the liquid dicarboxylic acid.

The introduction of nitrogen during the preparation process of the present disclosure can prevent the material from being oxidized at a high temperature, and can also blow out the generated small molecules to promote the forward progress of the reaction.

The multi-step heating involves a degree of reaction, the selection of reaction conditions is based on long-term experimental exploration, the reaction conditions are controlled, and the low-temperature time is extended as much as possible to increase a reaction proportion of amino, such that the activity of amino is higher than the activity of hydroxyl and thus hydroxyl is not easy to react at a low temperature. The temperature is maintained at 100° C. to 180° C. for a long time to make the amino in the monomer completely react as much as possible, such that the hydroxyl is still retained at a reaction end point and the generated polymer can be reprocessed. The multi-step heating and cooling is conducted to take out the material at a low temperature and prevent the material from being oxidized by air.

If reaction proportions or conditions are not within a specified range, the product has degraded mechanical properties, but still has reprocessibility. This is because the monomer feeding under conditions beyond the specified ranges causes the polymer to have many small molecules, resulting in deteriorated mechanical properties.

### BRIEF DESCRIPTION OF THE DRAWINGS

FIG. 1 is a schematic diagram illustrating a reaction structure of the tall oil-derived diacid in an example of the present disclosure.

FIG. 2 shows an infrared (IR) spectrum of the PEA in Example 1 of the present disclosure.

FIG. 3 shows stress-strain curves of PEAs in Examples 1-5 of the present disclosure.

FIG. 4 shows glass transition temperature changes of PEAs in Examples 1 to 5 of the present disclosure.

FIG. 5 shows the comparison of IR spectra of the PEA in Example 1 of the present disclosure that is repeatedly formed.

FIG. 6 shows comparison photos of the PEA in Example 1 of the present disclosure before and after repeated forming.

### DETAILED DESCRIPTION OF THE EMBODIMENTS

In order to make the objectives, technical solutions, and advantages of the examples of the present disclosure clearer, the technical solutions in the examples of the present disclosure will be clearly and completely described below with reference to the examples of the present disclosure. Apparently, the described examples are some rather than all of the examples. All other examples obtained by a person of ordinary skill in the art based on the examples of the present disclosure without creative efforts shall fall within the protection scope of the present disclosure.

The experimental materials, reagents, and the like used in the following examples are all commercially available, unless otherwise specified.

If specific techniques or conditions are not indicated in an example, a process shall be conducted in accordance with the techniques or conditions described in literatures in the art or in accordance with a product specification.

The tall oil-derived diacid in the following examples is provided by the MeadWestvaco (China) Holding Co., Ltd.

### Example 1

A PEA was prepared, specifically including the following steps:

32 g of a tall oil-derived diacid, 6.8 g of 1,3-diamino-2-propanol, and 80 mg of sodium phosphite were added to a three-necked flask. A resulting mixture was thoroughly stirred by a mechanical stirrer and under a nitrogen atmosphere. A resulting reaction system was heated to allow a reaction at 80° C. for 1 h, allow a reaction at 140° C. for 12 h, allow a reaction at 180° C. for 6 h, and allow a reaction at 230° C. for 2 h. The reaction system was finally cooled to 140° C.; and after the reaction was completed, a product was taken out and stored in a sealed container, which was named PEA 1.

As shown in FIG. 1, after the raw material tall oil-derived diacid of the present disclosure reacts according to Example 1, the peak of carboxyl groups basically disappears, and the peaks of amido and ester groups are newly generated, indicating that the reaction is successful and the amino group is basically converted into an amido group. In addition, due to the presence of hydroxyl groups, the hydroxyl groups react with carboxyl groups to produce ester groups, that is, the PEA is successfully prepared in the present disclosure.

The tall oil-derived diacid is a bifunctional mixture, and the tall oil-derived diacid is subjected to polycondensation with a trifunctional β-hydroxyl-containing monomer. The activity of the amino group is allowed to be higher than the activity of the hydroxyl group. The low-temperature reaction time is fully extended, such that the amino group reacts as much as possible and then the unreacted carboxyl groups and hydroxyl groups are cross-linked at a high temperature. Because the raw materials are fed according to a specified molar ratio, a quantity of carboxyl groups is always smaller than a total quantity of hydroxyl and amino groups, and there are still hydroxyl groups at a reaction end point as indicated by the hydroxyl peak at 3,300 cm⁻¹ in FTIR spectrum. In addition, according to the transesterification reaction mechanism, the cross-linked polymer has reprocessability.

### Example 2

A PEA was prepared, specifically including the following steps:

35.2 g of a tall oil-derived diacid, 6.8 g of 1,3-diamino-2-propanol, and 80 mg of sodium phosphite were added to a three-necked flask. A resulting mixture was thoroughly stirred by a mechanical stirrer. Under a nitrogen atmosphere, a resulting reaction system was heated to allow a reaction at 80° C. for 1 h, allow a reaction at 140° C. for 12 h, allow a reaction at 180° C. for 6 h, and allow a reaction at 230° C. for 2 h. The reaction system was finally cooled to 140° C. After the reaction was completed, a product was taken out and stored in a sealed container, which was named PEA 2.

### Example 3

A PEA was prepared, specifically including the following steps:

38.4 g of a tall oil-derived diacid, 6.8 g of 1,3-diamino-2-propanol, and 80 mg of sodium phosphite were added to a three-necked flask. A resulting mixture was thoroughly stirred by a mechanical stirrer. Under a nitrogen atmosphere, a resulting reaction system was heated to allow a reaction at 80° C. for 1 h, allow a reaction at 140° C. for 12 h, allow a reaction at 180° C. for 6 h, and allow a reaction at 230° C. for 2 h. The reaction system was finally cooled to 140° C.; and after the reaction was completed, a product was taken out and stored in a sealed container, which was named PEA 3.

### Example 4

A PEA was prepared, specifically including the following steps:

41.6 g of a tall oil-derived diacid, 6.8 g of 1,3-diamino-2-propanol, and 80 mg of sodium phosphite were added to a three-necked flask, a resulting mixture was thoroughly stirred by a mechanical stirrer, and under a nitrogen atmosphere, a resulting reaction system was heated to allow a reaction at 80° C. for 1 h, allow a reaction at 140° C. for 12 h, allow a reaction at 180° C. for 6 h, and allow a reaction at 230° C. for 2 h; the reaction system was finally cooled to 140° C.; and after the reaction was completed, a product was taken out and stored in a sealed container, which was named PEA 4.

### Example 5

A PEA was prepared, specifically including the following steps:

44.8 g of a tall oil-derived diacid, 6.8 g of 1,3-diamino-2-propanol, and 80 mg of sodium phosphite were added to a three-necked flask, a resulting mixture was thoroughly stirred by a mechanical stirrer, and under a nitrogen atmosphere, a resulting reaction system was heated to allow a reaction at 80° C. for 1 h, allow a reaction at 140° C. for 12 h, allow a reaction at 180° C. for 6 h, and allow a reaction at 230° C. for 2 h; the reaction system was finally cooled to 140° C.; and after the reaction was completed, a product was taken out and stored in a sealed container, which was named PEA 5.

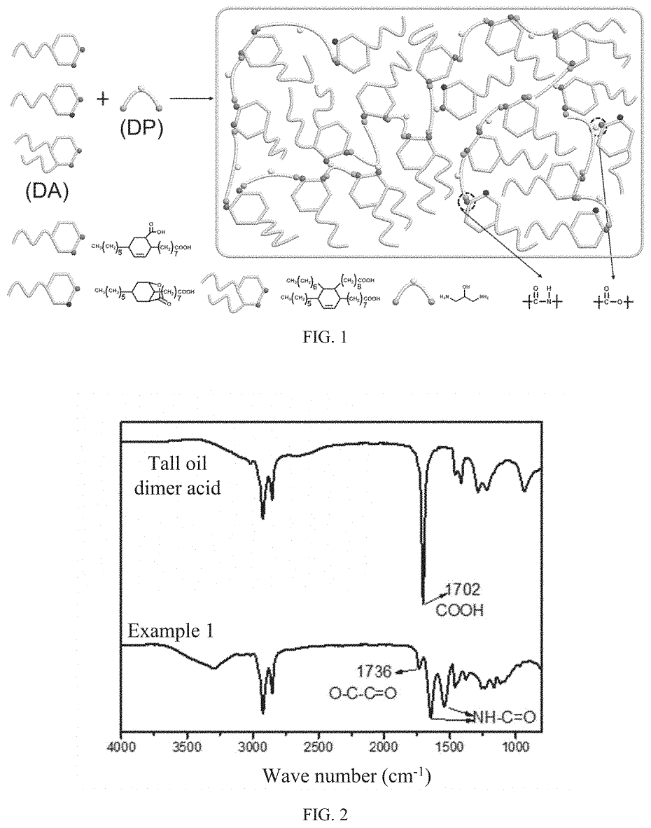

The tall oil-derived diacid is a multi-component mixture, and FIG. 2 is a conceptual diagram of the reaction of the tall oil-derived diacid.

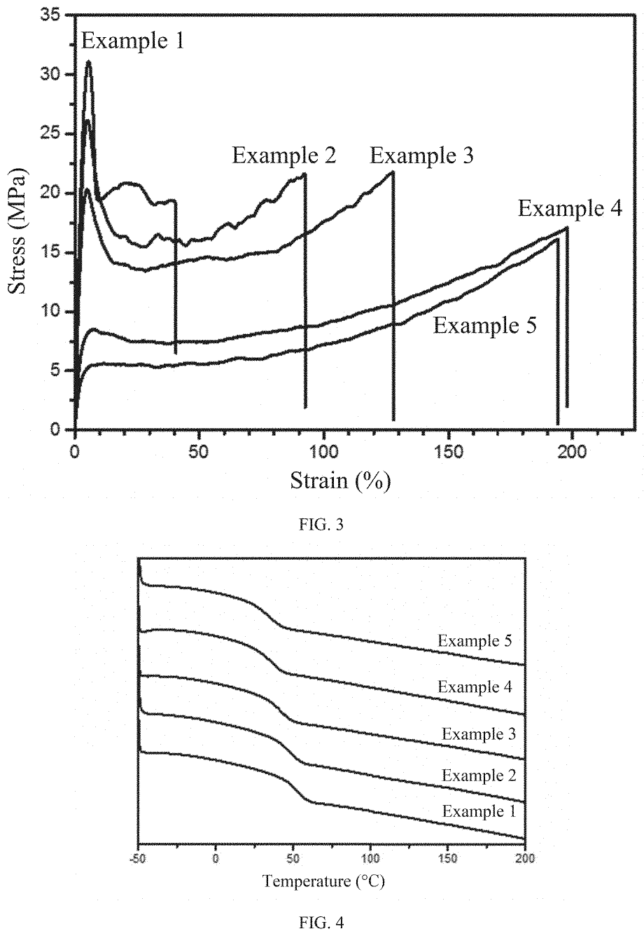

As shown in FIG. 3, it can be seen from the preparation of PEAs 1, 2, 3, 4, and 5 that, with the content of 1,3-diamino-2-propanol unchanged, as the tall oil-derived diacid content increases, the material gradually transitions from a plastic to an elastomer in terms of mechanical properties. The tensile properties of a sample stripe were tested according to GB/T 1040.3-2006 at a tensile rate of 10 mm/min, a constant temperature, and a constant humidity.

As shown in FIG. 4, it can be seen from the preparation of PEAs 1, 2, 3, 4, and 5 that, with the content of 1,3-diamino-2-propanol unchanged, as the tall oil-derived diacid content increases, the glass transition temperature of the material gradually decreases.

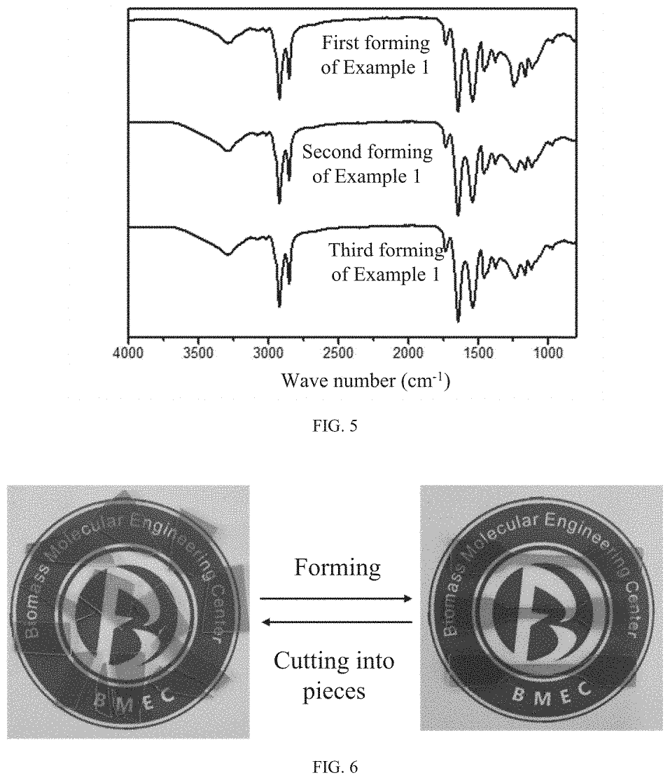

As shown in FIG. 5, after the PEA 1 is repeatedly formed, groups indicated by IR spectroscopy do not change, indicating that the material can be reprocessed.

As shown in FIG. 6, after being preformed, the PEA 1 can still be cut into pieces and formed.

The above examples are used only to describe the technical solutions of the present disclosure, and are not intended to limit the present disclosure. Although the present disclosure is described in detail with reference to the above examples, those of ordinary skill in the art should understand that they can still modify the technical solutions described in the above examples, or make equivalent substitutions to some technical features therein. These modifications or substitutions do not make the essence of the corresponding technical solutions depart from the spirit and scope of the technical solutions of the examples of the present disclosure.

What is claimed is:

1. A preparation method of a reprocessable thermosetting polyesteramide (PEA), comprising the following steps:
(1) mixing 30 to 200 parts by weight of a liquid dicarboxylic acid and 15 to 95 parts by weight of a β-hydroxyl-containing diamine compound to obtain a first mixture, heating the first mixture for dissolution to obtain a dissolved mixture, and stirring the dissolved mixture evenly to obtain a reaction solution;
(2) adding 0.05 to 0.5 parts by weight of a catalyst to the reaction solution to obtain a second mixture, and heating the second mixture under a nitrogen atmosphere to allow a first reaction at 65° C. to 100° C. for 1 h to 6 h to obtain a first reaction system;
(3) heating the first reaction system obtained in step (2) to allow a second reaction at 100° C. to 180° C. for 3 h to 18 h to obtain a second reaction system;
(4) heating the second reaction system obtained in step (3) to allow a third reaction at 180° C. to 240° C. for 0.5 h to 4 h to obtain a third reaction system;
(5) cooling the third reaction system obtained in step (4) to 100° C. to 180° C. to obtain the reprocessable thermosetting PEA.

2. The preparation method of the reprocessable thermosetting PEA according to claim 1, wherein the liquid dicarboxylic acid has a structural formula of 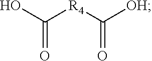
and the β-hydroxyl-containing diamine compound has a structural formula of

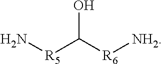

3. The preparation method of the reprocessable thermosetting PEA according to claim 1, wherein the catalyst comprises any one selected from the group consisting of sodium phosphite, sodium hypophosphite (SHP), and zinc acetate.

4. The preparation method of the reprocessable thermosetting PEA according to claim 1, wherein the liquid dicarboxylic acid comprises one or more selected from the group consisting of the following structural formulas:

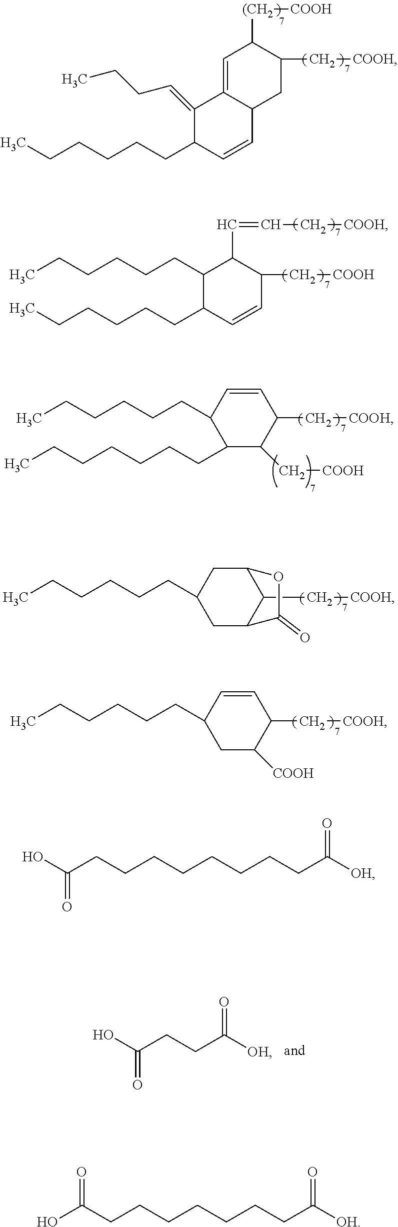

5. The preparation method of the reprocessable thermosetting PEA according to claim 1, wherein the β-hydroxyl-containing diamine compound is 1,3-diamino-2-propanol.

6. The preparation method of the reprocessable thermosetting PEA according to claim 1, wherein the liquid dicarboxylic acid comprises a tall oil-derived diacid.

7. The preparation method of the reprocessable thermosetting PEA according to claim 5, comprising the following steps:
(1) mixing 41.6 g of a tall oil-derived diacid and 6.8 g of the 1,3-diamino-2-propanol to obtain the first mixture, heating the first mixture for dissolution to obtain the dissolved mixture, and stirring the dissolved mixture evenly to obtain a reaction solution;
(2) adding 80 mg of sodium phosphite to the reaction solution to obtain the second mixture, and heating the second mixture under the nitrogen atmosphere to allow the first reaction at 80° C. for 1 h to obtain the first reaction system;
(3) heating the first reaction system obtained in step 2 to allow the second reaction at 140° C. for 12 h and then allow a fourth reaction at 180° C. for 6 h to obtain the second reaction system;
(4) heating the second reaction system obtained in step 3 to allow the third reaction at 230° C. for 2 h to obtain the third reaction system; and
(5) cooling the third reaction system obtained in step 4 to 140° C. to obtain the reprocessable thermosetting PEA.

8. The preparation method of the reprocessable thermosetting PEA according to claim 5, comprising the following steps:
(1) mixing 38.4 g of a tall oil-derived diacid and 6.8 g of the 1,3-diamino-2-propanol to obtain the first mixture, heating the first mixture for dissolution to obtain the dissolved mixture, and stirring the dissolved mixture evenly to obtain a reaction solution;
(2) adding 80 mg of sodium phosphite to the reaction solution to obtain the second mixture, and heating the second mixture under the nitrogen atmosphere to allow the first reaction at 80° C. for 1 h to obtain the first reaction system;
(3) heating the first reaction system obtained in step (2) to allow the second reaction at 140° C. for 12 h and then allow a fourth reaction at 180° C. for 6 h to obtain the second reaction system;
(4) heating the second reaction system obtained in step (3) to allow the third reaction at 230° C. for 2 h to obtain the third reaction system; and
(5) cooling the third reaction system obtained in step (4) to 140° C. to obtain the reprocessable thermosetting PEA.

9. The preparation method of the reprocessable thermosetting PEA according to claim 5, comprising the following steps:
(1) mixing 35.2 g of a tall oil-derived diacid and 6.8 g of the 1,3-diamino-2-propanol to obtain the first mixture, heating the first mixture for dissolution to obtain a dissolved mixture, and stirring the dissolved mixture evenly to obtain a reaction solution;
(2) adding 80 mg of sodium phosphite to the reaction solution to obtain a second mixture, and heating the second mixture under the nitrogen atmosphere to allow the first reaction at 80° C. for 1 h to obtain a first reaction system;
(3) heating the first reaction system obtained in step (2) to allow the second reaction at 140° C. for 12 h and then allow a fourth reaction at 180° C. for 6 h to obtain the second reaction system;
(4) heating the second reaction system obtained in step (3) to allow the third reaction at 230° C. for 2 h to obtain the third reaction system; and
(5) cooling the third reaction system obtained in step (4) to 140° C. to obtain the reprocessable thermosetting PEA.

10. The preparation method of the reprocessable thermosetting PEA according to claim 5, comprising the following steps:
(1) mixing 44.8 g of a tall oil-derived diacid and 6.8 g of the 1,3-diamino-2-propanol to obtain a first mixture, heating the first mixture for dissolution to obtain a dissolved mixture, and stirring the dissolved mixture evenly to obtain a reaction solution;
(2) adding 80 mg of sodium phosphite to the reaction solution to obtain a second mixture, and heating the second mixture under the nitrogen atmosphere to allow the first reaction at 80° C. for 1 h to obtain a first reaction system;
(3) heating the first reaction system obtained in step (2) to allow the second reaction at 140° C. for 12 h and then allow a fourth reaction at 180° C. for 6 h to obtain the second reaction system;
(4) heating the second reaction system obtained in step (3) to allow the third reaction at 230° C. for 2 h to obtain the third reaction system; and
(5) cooling the third reaction system obtained in step (4) to 140° C. to obtain the reprocessable thermosetting PEA.

11. A reprocessable thermosetting PEA prepared by the preparation method according to claim 1.

12. The reprocessable thermosetting PEA according to claim 11, wherein in the preparation method, the liquid dicarboxylic acid has a structural formula of 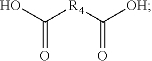
and the β-hydroxyl-containing diamine compound has a structural formula of

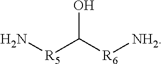

13. The reprocessable thermosetting PEA according to claim 11, wherein in the preparation method, the catalyst comprises any one selected from the group consisting of sodium phosphite, sodium hypophosphite (SHP), and zinc acetate.

14. The reprocessable thermosetting PEA according to claim 11, wherein in the preparation method, the liquid dicarboxylic acid comprises one or more selected from the group consisting of the following structural formulas:

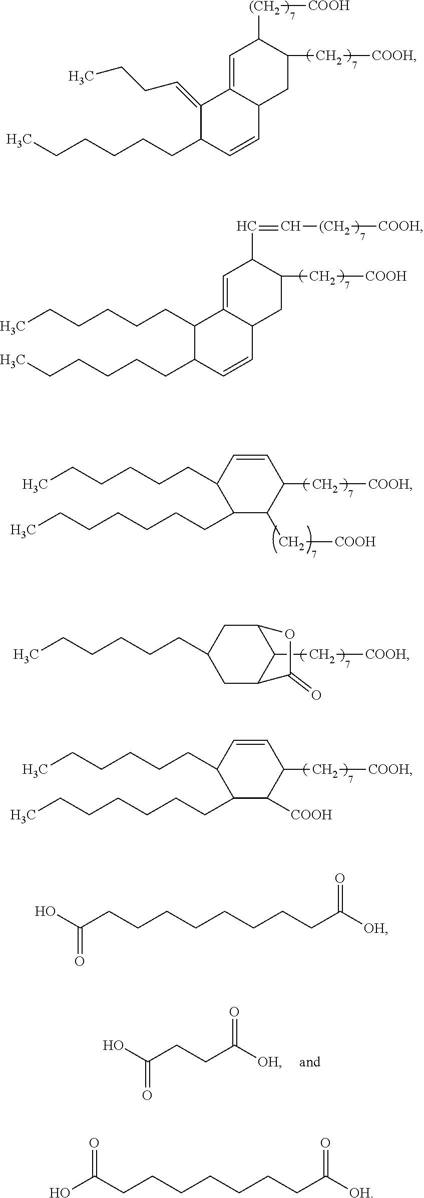

15. The reprocessable thermosetting PEA according to claim 11, wherein in the preparation method, the β-hydroxyl-containing diamine compound is 1,3-diamino-2-propanol.

16. The reprocessable thermosetting PEA according to claim 11, wherein in the preparation method, the liquid dicarboxylic acid comprises a tall oil-derived diacid.

17. The reprocessable thermosetting PEA according to claim 15, wherein the preparation method comprises the following steps:
(1) mixing 41.6 g of a tall oil-derived diacid and 6.8 g of the 1,3-diamino-2-propanol to obtain the first mixture, heating the first mixture for dissolution to obtain the dissolved mixture, and stirring the dissolved mixture evenly to obtain a reaction solution;
(2) adding 80 mg of sodium phosphite to the reaction solution to obtain the second mixture, and heating the second mixture under the nitrogen atmosphere to allow the first reaction at 80° C. for 1 h to obtain the first reaction system;
(3) heating the first reaction system obtained in step 2 to allow the second reaction at 140° C. for 12 h and then allow a fourth reaction at 180° C. for 6 h to obtain the second reaction system;
(4) heating the second reaction system obtained in step 3 to allow the third reaction at 230° C. for 2 h to obtain the third reaction system; and
(5) cooling the third reaction system obtained in step 4 to 140° C. to obtain the reprocessable thermosetting PEA.

18. The reprocessable thermosetting PEA according to claim 15, wherein the preparation method comprises the following steps:
(1) mixing 38.4 g of a tall oil-derived diacid and 6.8 g of the 1,3-diamino-2-propanol to obtain the first mixture, heating the first mixture for dissolution to obtain the dissolved mixture, and stirring the dissolved mixture evenly to obtain a reaction solution;
(2) adding 80 mg of sodium phosphite to the reaction solution to obtain the second mixture, and heating the second mixture under the nitrogen atmosphere to allow the first reaction at 80° C. for 1 h to obtain the first reaction system;
(3) heating the first reaction system obtained in step (2) to allow the second reaction at 140° C. for 12 h and then allow a fourth reaction at 180° C. for 6 h to obtain the second reaction system;
(4) heating the second reaction system obtained in step (3) to allow the third reaction at 230° C. for 2 h to obtain the third reaction system; and
(5) cooling the third reaction system obtained in step (4) to 140° C. to obtain the reprocessable thermosetting PEA.

19. The reprocessable thermosetting PEA according to claim 15, wherein the preparation method comprises the following steps:
(1) mixing 35.2 g of a tall oil-derived diacid and 6.8 g of the 1,3-diamino-2-propanol to obtain the first mixture, heating the first mixture for dissolution to obtain a dissolved mixture, and stirring the dissolved mixture evenly to obtain a reaction solution;
(2) adding 80 mg of sodium phosphite to the reaction solution to obtain a second mixture, and heating the second mixture under the nitrogen atmosphere to allow the first reaction at 80° C. for 1 h to obtain a first reaction system;
(3) heating the first reaction system obtained in step (2) to allow the second reaction at 140° C. for 12 h and then allow a fourth reaction at 180° C. for 6 h to obtain the second reaction system;
(4) heating the second reaction system obtained in step (3) to allow the third reaction at 230° C. for 2 h to obtain the third reaction system; and
(5) cooling the third reaction system obtained in step (4) to 140° C. to obtain the reprocessable thermosetting PEA.

20. The reprocessable thermosetting PEA according to claim 15, wherein the preparation method comprises the following steps:
(1) mixing 44.8 g of a tall oil-derived diacid and 6.8 g of the 1,3-diamino-2-propanol to obtain a first mixture, heating the first mixture for dissolution to obtain a dissolved mixture, and stirring the dissolved mixture evenly to obtain a reaction solution;
(2) adding 80 mg of sodium phosphite to the reaction solution to obtain a second mixture, and heating the second mixture under the nitrogen atmosphere to allow the first reaction at 80° C. for 1 h to obtain a first reaction system;
(3) heating the first reaction system obtained in step (2) to allow the second reaction at 140° C. for 12 h and then allow a fourth reaction at 180° C. for 6 h to obtain the second reaction system;
(4) heating the second reaction system obtained in step (3) to allow the third reaction at 230° C. for 2 h to obtain the third reaction system; and
(5) cooling the third reaction system obtained in step (4) to 140° C. to obtain the reprocessable thermosetting PEA.
